(19) United States
(12) Patent Application Publication
(10) Pub. No.: US 2020/0300434 A1
(43) Pub. Date: Sep. 24, 2020

(54) LIGHTING UNIT FOR A LIGHT DEVICE OF A MOTOR VEHICLE AND A LIGHT DEVICE WITH THE LIGHTING UNIT

(71) Applicant: Varroc Lighting Systems, s.r.o., Senov u Noveho Jicina (CZ)

(72) Inventors: Tomas Gloss, Vitkov (CZ); Vit Simurda, Novy Jicin (CZ); Jakub Hruska, Hlucin (CZ)

(21) Appl. No.: 16/823,907

(22) Filed: Mar. 19, 2020

(30) Foreign Application Priority Data
Mar. 22, 2019 (CZ) PV 2019-176

(51) Int. Cl. F21S 41/24; F21V 8/00; F21S 41/25; G02B 7/02

(52) U.S. Cl. CPC F21S 41/24; G02B 7/027; F21S 41/25; G02B 6/0023

(57) ABSTRACT

The lighting unit (3) comprises a light guide (15) to lead light rays (10) from at least one light source (11) wherein the light guide (15) comprises the front surface (17) and the opposite rear surface (18). The front surface (17) comprises exit areas (30) for the exit of light rays (10) from the light guide (15), and intermediate areas (19) positioned between the exit areas (30) and configured for total reflection of light rays (10) passing along the light guide (15). The lighting unit (3) further comprising a light assembly (23) situated against the front surface (17) of the light guide (15) and comprising optical elements (26) containing a bearing area (14) with which the optical elements (26) are connected to the opposite exit areas (30) directly or indirectly in such a way that transitional layers (24) are situated between the exit areas (30) and bearing areas (14). The optical elements (26) are configured to bind light rays (10) falling onto the exit areas (30) and to emit them from the exit surface (29) of the optical elements (26) averted from the light guide (15), in a predetermined direction or directions.

### RELATED APPLICATIONS

This application claims the priority benefit of Czech Patent Application Serial No. PV 2019-176 entitled “A lighting unit for a light device of a motor vehicle and a light device with the lighting unit,” filed Mar. 22, 2019, the entire disclosure of which is incorporated herein by reference.

### FIELD OF THE INVENTION

The invention relates to a lighting unit for a light device of a motor vehicle and a light device with the lighting unit.

### BACKGROUND INFORMATION

New vehicle lighting systems do not only focus on the optical output increasing the driving comfort and traffic safety, but it is also the appearance that is important for modern light devices of motor vehicles as headlights or signal lamps of a motor vehicle. Modern point and planar light sources, especially LED and OLED sources, have opened a new chapter for new stylistic options of car designers.

Using a planar light source, especially OLED—Organic Light Emitting Diodes—brings not only an extension of designer possibilities of the emitted light function, but it is also characterized by certain technical benefits including e.g. compact installation dimensions, low heat production, low energy consumption etc. Unfortunately, there are still some limitations of the OLED technology preventing widespread deployment of this technology in the serial production of car lighting. E.g. service life, penetration of moisture, low luminance for power functions, limitation to planar surfaces only and last, but not least, a high price. Another drawback of the OLED technology is the fact that a lamp of a motor vehicle must be adapted do detect an error status of the light source. With conventional LED's, this condition can be detected relatively well because in most cases, a short circuit or diode disconnection occurs, which results in a change of an electric quantity that can be relatively easily electronically detected. The situation of planar sources is more complicated because OLED's comprise organic layers that emit light after connection of electric voltage/current.

In the patent references U.S. Pat. Nos. 9,335,460, 7,651,241, 5,791,757, US20160356942, US20160349570, US20150331169, US20140268873, US20130033895, US20110249939, US20110170315, US20100309677, US20080186726, GB2537088, KR2008111786, there are many solutions that use a planarly shaped lighting unit equipped with an exit area for the output of light rays without using organic substances such as OLED. The disadvantage of the above-mentioned design solutions is that these lighting units are not intended to be used as external lighting equipment for motor vehicles, for which a variety of technical specifications and regulatory requirements must be followed and fulfilled. There is also a requirement for low manufacturing and assembly costs of such devices. For example, chemically cured cover glass that is used in the manufacturing process of screens is unsuitable for use as a cover glass of motor vehicle headlights as its manufacturing costs are too high.

To achieve the highest possible efficiency of light devices, efficient binding of light rays to light-guiding components must be ensured. Individual optical elements as a system of refractive and reflective surfaces and interfaces of optical environments must be arranged in such a way to prevent light losses to the highest possible extent, and at the same time to create an output light trace with the required light characteristic, i.e. the required light intensity and homogeneous appearance with constant luminance all over the exit surface.

Car lighting has certain specific features as it is not only the appearance and the total luminance of the lighting function that is concerned. Individual lighting functions must conform to locally valid legislative regulations (e.g. ECE, SAE, CCC etc.). Each function has different requirements for the minimal and maximal luminous intensity values at certain angles. This means that the purpose is not only to emit a certain amount of light from lighting elements. It is also necessary to emit light having certain luminous intensity at individual angles specified by the legislation. This luminous intensity is based on the minimum and maximum values in individual regulations for individual angles. A lighting function should be preferably designed in such a way to meet requirements of as many regulations as possible. So there is a certain overlap of the intervals of the specified minimum and maximum values for individual angles. In this case, a lamp or headlight can be used for more markets at the same time without changes. However, there are cases when the requirements of all regulations cannot be met with the use of a single design of a lighting function. In that case, the lighting function must be adapted to the requirements of individual markets, which results in a unique product for the particular market.

The requirements for the luminous intensity at individual angles are based on traffic safety requirements. This is because the primary task of signal lights is to make sure that a vehicle that emits a signal can be seen from angles that are critical for the particular function. All the signal functions (except the lateral ones) must emit light with the highest possible luminous intensity in the vehicle axis direction. The requirements for individual luminous intensity values at individual angles then decrease with the increasing angle of deflection from this axis. This decrease is gradual and does not approximate Lambert's distribution (cosine emitter). Thus, it is not desirable to strive to achieve this (Lambertian) distribution, which is close to the distribution that OLED lights or some displays work with. Concerning displays and TV screens, the aim is to ensure as constant luminance as possible from the widest possible viewing angles, which is a principal difference from the requirements for angular luminous intensities that light devices of motor vehicles, i.e. also the light device of a motor vehicle according to the present invention, are subject to.

As indicated above, fading at large viewing angles is rather considered as a defect in the case of displays and TV screens. On the other hand, signal lights of motor vehicles are subject to specifications what luminous intensities must be achieved at what angles to ensure safe visibility of a vehicle emitting a signal. In most cases, a light cone must be produced having the highest luminous intensity within the angle of +/−10° horizontally and +/−5° vertically from the longitudinal axis of the vehicle. Lower luminous intensities are then required up to the angles of +/−20° horizontally and +/−10° vertically from the vehicle axis. These angles are required for the main beam, the luminous intensity of the main beam being several times higher than the required luminous intensity at the other angles. At the other angles, visibility is the relevant parameter. I.e. a requirement for the signal to be visible from a large range of angles. E.g. for the stop function, visibility is required in the angular range of +/−45° horizontally and +/−15° vertically. However, for the tail light and the turn indicator function the visibility angle out of the vehicle has been extended up to 80°. With regard to the production tolerances it is then important to design the light function in such a way as to always meet the required luminous intensity value at the particular angle. Therefore, the minimal and maximal values are designed with a certain angular and value margin. This e.g. means that if a minimal luminous intensity is required up to a certain angle, the function is mostly designed in such a way for this minimal value to exceed the given angular direction by at least 1.5°.

The above-mentioned description implies that to efficiently meet the legislative regulations, the light must be directed specifically at individual angles.

Unlike displays and TV screens, in the automotive industry, the required shape of the output surface must further be considered. This is because in most cases, the use of a simple square or rectangular surface is not acceptable from a designer point of view. Today, the style of a car is a very important parameter and at the same time a limit for meeting technical and legislative requirements. Therefore, style must be combined with technological features to achieve the desired result. For this reason, within the design of the light-conductive core, the distribution and size of unbinding elements must be optimized.

The references CZ2017480 and CZ20180107 describe light devices for motor vehicles that comprise a panel-shaped shaped lighting unit with an exit area of light rays. The lighting unit is powered by spot light sources, in particular by LED, and it is equipped with optical elements to create signal light functions while the panel-shaped shaped lighting unit offers stylistic advantages comparable to the OLED technology. It is ensured that all technical specifications and legal requirements for use of lighting equipment in the automotive industry are fulfilled. The light device comprises a light-conductive core from an optically transparent material with an associated light unit situated against the entry area of the light-conductive core. The lighting unit further comprises a functional layer arranged between the light-conductive core and the translucent cover and configured to focus the beams of light rays that exit its surface averted from the light-conductive core in a predetermined direction, and a technological layer (situated in contact with the top surface of the light-conductive core and configured for total reflection of light rays). The lighting unit further comprises separators situated on the top surface of the light conductive core to delimit the required thickness of the technological layer. A disadvantage of these designs is the fact that the light rays are diffused with a relatively large lateral dispersion. This assembly achieves a lateral dispersion for the required luminous intensity of approx. 60°. Within the dispersion region of 60°, an almost homogeneous distribution of light is achieved on the display area whereas in the field of automotive lighting equipment it is desirable to emit a large amount of light especially in the vehicle axis direction and to diffuse a certain amount of light. Another drawback of the above-mentioned designs is the entire structural arrangement of the optical parts, which does not enable their variable configuration based on designer requirements, e.g. if it is necessary to direct the light beam in a certain manner, or if a spatial shape of an optical element is to be achieved.

The object of the invention is to disclose a new design of a light device of a motor vehicle that comprises a panel-shaped lighting unit with an exit area of light rays that will offer designer advantages comparable to the OLED technology and at the same time ensure that all technical specifications and legal requirements for use of lighting equipment in the automotive industry are fulfilled at acceptable manufacturing costs.

### SUMMARY OF THE INVENTION

The above-mentioned object of the invention is fulfilled by a lighting unit according to the invention, intended for a light device of a motor vehicle, comprising a light guide to lead light rays from at least one light source. The light guide comprises a front surface and an apposite rear surface. The front surface comprises exit areas for the output of light rays from the light guide and intermediate areas situated between the exit areas and configured for total reflection of light rays passing along the light guide. The lighting unit further includes a light assembly situated against the front surface of the light guide and comprising optical elements containing a bearing area through which the optical elements are connected with the opposite exit areas directly or indirectly in such a way that between the exit areas and bearing areas transitional layers are arranged. The optical elements are configured to bind light rays falling onto the exit areas and to emit them from the exit surface of the optical elements, averted from the light guide, in a predetermined direction or directions.

In one of preferred embodiments, the rear surface of the light guide is smooth and without unbinding elements so that the light guide is virtually configured for the exit of light rays out of the light guide through the exit areas only.

In another one of preferred embodiments, the rear surface of the light guide is fitted with unbinding elements configured to direct light rays towards the exit areas and/or intermediate areas and to ensure their exit through the exit areas and/or intermediate areas out of the light guide.

The light assembly may preferably comprise a carrier carrying optical elements.

In another one of preferred embodiments, the optical element comprises a functional element and an emitting element, which are directly or indirectly connected to each other, the functional element comprising a bearing area and at least one reflective area to reflect light rays that have left the light guide through the exit area and entered the functional element through the bearing area, and to direct them to the emitting element comprising an exit surface for the exit of light rays out of the functional element.

In another one of preferred embodiments, the functional elements protrude from the rear surface of the carrier facing the front surface of the light guide and the emitting elements protrude from the front surface of the carrier averted from the front surface of the light guide.

The optical elements may preferably be integral bodies embedded in the carrier.

In another one of preferred embodiment, the functional elements and the emitting elements are separated from each other by the carrier.

The said transitional layers may preferably be part of a monolithic layer.

In one of preferred embodiments, the light guide is longitudinally shaped or panel-shaped. The carrier may be advantageously panel-shaped or longitudinally shaped as well.

In another one of preferred embodiments, the emitting elements have the form of ball-shaped lenses with a convex shape of the exit area and the functional element has the shape of a truncated cone whose base is the bearing area.

In another one of preferred embodiments, the emitting elements have an elongated shape, especially the shape of cylindrical lenses.

In another one of preferred embodiments, at least two of the emitting elements differ from each other with their shape and/or size.

In another one of preferred embodiments, the lighting unit includes a filter located behind the light guide to influence the color background when the lighting unit is viewed in its inactive state.

In another one of preferred embodiments, the lighting unit comprises a filter, especially homogenizer adapted for homogenization—diffusion of light rays, the filter being situated at a distance in front of the optical assembly and comprising a superficial or internal volume structure to influence the flow direction of the light rays, or the filter being colored or metal-plated in a semi-permeable way.

The thickness of the lighting unit is preferably from 0.1 mm to 14 mm.

The invention also relates to a light device comprising the lighting unit described above, situated to emit light rays from the exit areas of the optical elements out of the light device.

The light device may advantageously comprise multiple lighting units to serve one or more light functions of the light device.

### CLARIFICATION OF DRAWINGS

The present invention will be further clarified in more detail with the use of its embodiment examples referring to the enclosed drawings wherein:

FIG. 1 shows a side view of the first embodiment example of the lighting unit according to the invention with a schematic representation of the route of light rays,

FIG. 2 shows a detail of an embodiment of an optical element,

FIGS. 3A, 3B, 3C, 3D, 3E, and 4A show embodiment examples of the optical elements carried by the carrier in a front view,

FIG. 4B shows cross-section A-A′ of the optical element shown in FIG. 4a,

FIG. 5 shows a side view of another embodiment example of the lighting unit,

FIG. 6 shows a side view of another embodiment example of the lighting unit,

FIG. 7A shows a side view of another embodiment example of the lighting unit,

FIG. 7B shows a side view of another embodiment example of the lighting unit,

FIG. 8 shows a side view of another embodiment example of the lighting unit,

FIG. 9 shows a top view of another embodiment example of a light device of a motor vehicle according to the invention,

FIG. 10 shows a side view of another embodiment example of the lighting unit,

FIG. 11 shows a side view of another embodiment example of the lighting unit,

FIG. 12 shows a side view of another embodiment example of the lighting unit,

FIG. 13A shows a side view of another embodiment example of the lighting unit,

FIG. 13B shows a side view of another embodiment example of the lighting unit,

FIGS. 14A and 14B show a cross-section of an optical element carried by the carrier of a motor vehicle with the lighting unit according to the invention,

FIG. 15A shows a side view of another embodiment example of the lighting unit,

FIG. 15B shows a side view of another embodiment example of the lighting unit,

FIG. 16 shows a front view of an embodiment example of a light device of a motor vehicle with the lighting unit according to the invention, and

FIG. 17 shows a front view of another example of the light device.

### EXAMPLES OF EMBODIMENTS OF THE INVENTION

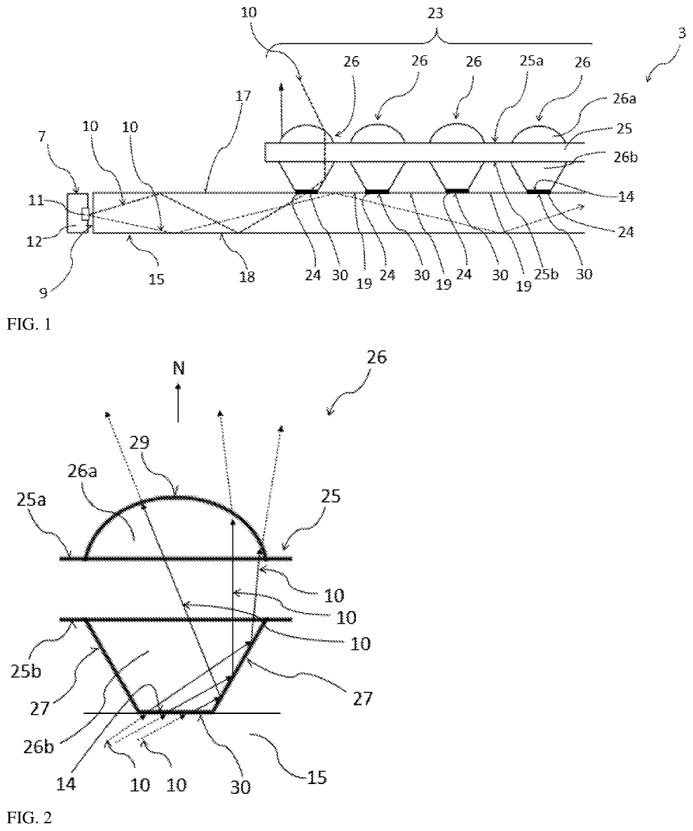

FIGS. 1 to 15b show embodiment examples of the lighting unit 3 according to the invention.

The lighting unit 3 comprises a light guide 15 made of an optically transparent material, with an associated light unit 7 comprising light sources 11 situated on a carrier 12. The light guide 15 can e.g. be of a plate-like shape (a panel-shaped light guide) and have a constant or variable thickness, or be of an elongated shape (rod light guide), it may be straight, bent, undulated or spatially shaped. The light sources 11 are situated at the entry area 9 of the light guide 15 and are designed to emit light rays 10 into the light guide 15. These light rays 10 pass along the light guide 15 using the total reflection principle, which occurs on the rear surface 18 and front surface 17 of the light guide 15 which form interfaces between the light guide 15 and the surroundings of the light guide 15 with a low refractive index with respect to the refractive index of the light guide 15 material, except the exit areas 30 designed specifically for the exit of light rays 10 out of the light guide 15 as described in detail below. The front surface 17 of the light guide 15 comprises exit areas 30 and intermediate areas 19 that separate the exit areas 30 from each other.

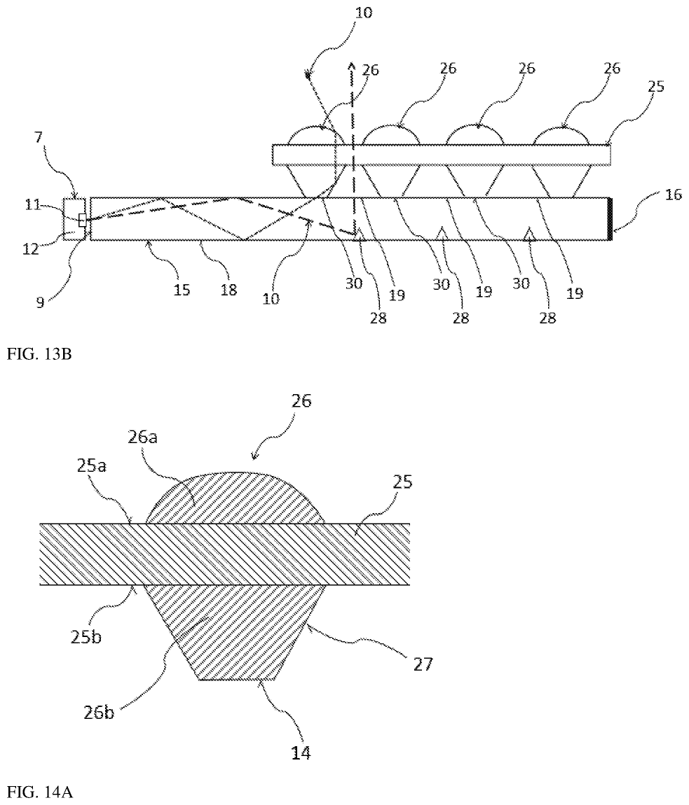

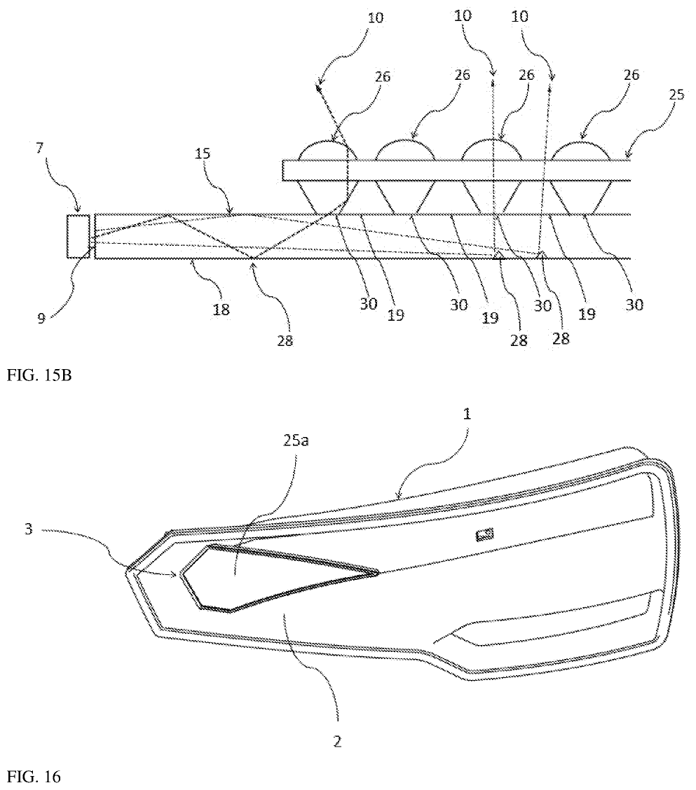

The rear surface 18 of the light guide 15 can be (see the embodiments of FIGS. 13a, 13b, 15b) fitted with unbinding elements 28 configured to direct light rays 10 in predetermined directions towards the front surface 17 of the light guide 15 to make the light rays 10 exit from the light guide 15. In such a case, the light rays 10 can, by the effect of the unbinding elements 28, also exit from the front surface 17 through the intermediate areas 19 (see FIGS. 13b and 15b), which are situated between the exit areas 30. The unbinding elements 28 can be e.g. designed as a tooth-like structure. However, in the other presented embodiments, the rear surface of the light guide 15 does not comprise any unbinding elements and is smoother, and therefore light rays 10 virtually only exit from the front surface 17 of the light guide 15 through the exit areas 30.

The lighting unit 3 further comprises an optical assembly 23 situated against at least a part of the front surface 17 of the light guide 15 in such a way that the optical assembly 23 virtually follows the shape of the opposite front surface 17. The optical assembly 23 always comprises optical elements 26. Each optical element 26 contains an emitting element 26a and a functional element 26b. The optical assembly 23 can further comprise a carrier 15 (it is the case of the embodiments shown in FIGS. 1 to 14b and 15b) carrying the optical elements 26 in such a way that the emitting elements 26a protrude from the front surface 25a of the carrier 25 and the functional elements 26b protrude from the rear surface 25b of the carrier 25. The invention also envisages embodiments wherein the optical assembly 23 does not comprise a carrier 25 (see FIG. 15a), and in such a case, the optical elements 26 are carried by the light guide 15.

The emitting elements 26a and functional elements 26b are preferably arranged in mutual alignment opposite each other as in the case of the presented preferred embodiments. Each pair of an emitting element 26a and functional element 26b is part of one optical element 26. However, the invention also envisages embodiments wherein the emitting element 26a and functional element 26b from which light rays 10 proceed to the emitting element 26a assigned to this functional element 26b are situated at a distance from each other, to which, however, the geometry and shape of these elements must be adapted, to achieve the desired propagation of light rays 10 from the functional element 26b to the emitting element 26a. In this case, the functional element 26b and the emitting element 26a assigned to it are considered as parts of one optical element 26.

The said carrier 25 may be e.g. foil.

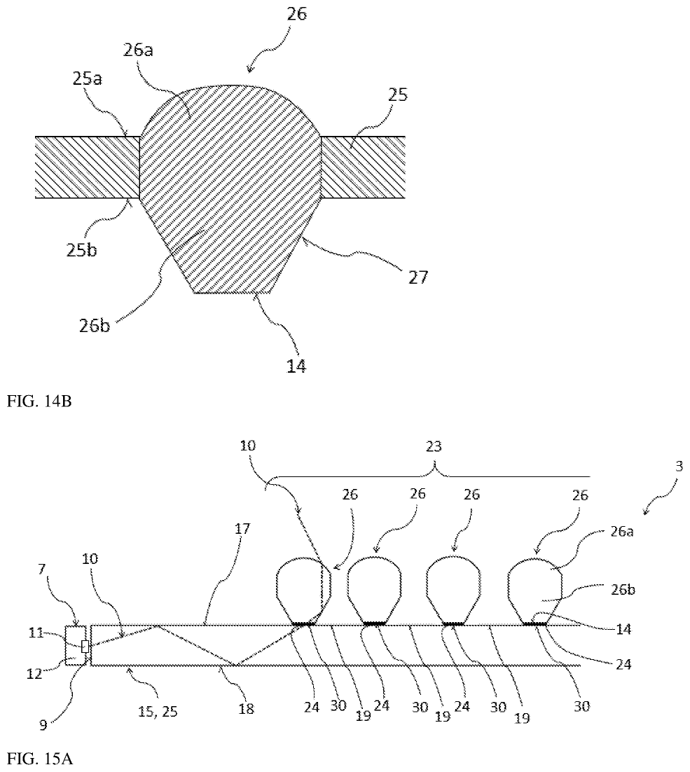

The optical element 26 comprising a functional element 26b and an emitting element 26a assigned to it can be an integral optical element 26 that is embedded in the carrier 25 as shown in FIG. 14a, displaying a cross-section of the optical element 26. However, such an embodiment is also possible wherein the emitting element 26a and the functional element 26b are two mutually separated parts included in the optical element 26 and attached to the carrier 25 as shown in FIG. 14b. The functional element 26b comprises a bearing area 14 situated opposite the respective exit area 30 of the light guide 15.

The shape of the functional elements 26b is configured to direct light rays 10 in predetermined directions to push the light rays 10 to the emitting elements 26a from where they are emitted out of the lighting unit 3. The functional elements 26b are further configured to bind light rays 10 from the exit areas 30 through the bearing area 14 into the functional elements 26b. The emitting element 26a is configured to emit a beam or beams of light rays 10 in a predetermined direction of directions and/or in a predetermined angular range. The functional elements 26b and emitting elements 26a usually have a size on the order of nanometers, micrometers to millimeters, e.g. in the range from 10 μm to 2000 μm.

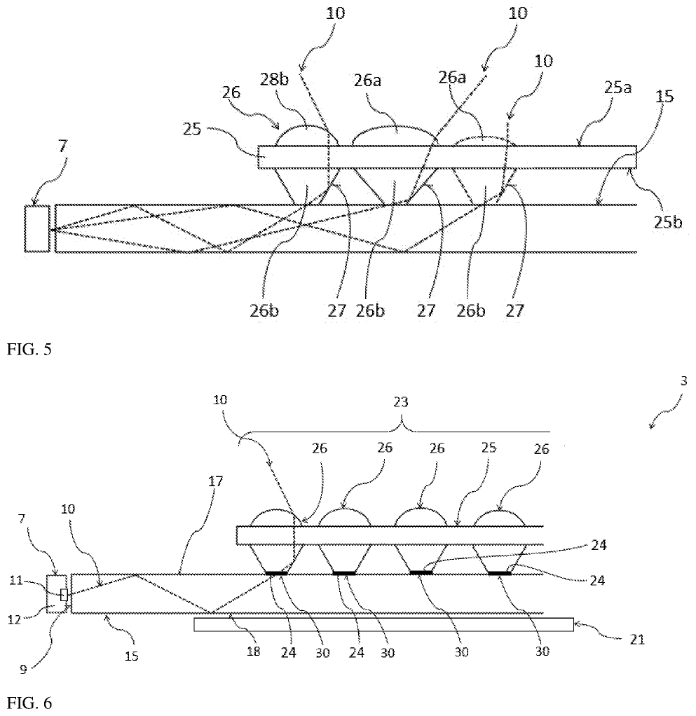

The optical elements 26 are attached directly or indirectly to the exit areas 30 of the light guide 15 with their bearing areas 14. As direct attachment (see e.g. FIG. 5) such a case is understood when the bearing area 14 of the functional element 26b directly bears on the exit area 30 of the light guide 15 and the bearing areas 14 and the exit areas 30 are connected to each other with a suitable technology that does not require any connecting material as e.g. an adhesive to be added between the bearing areas 14 and exit areas 30 to establish this connection. Such a technology may be e.g. vibration or laser welding or mechanical joining by sealing the functional elements 26b into the exit surface 30 of the light guide 15. In other preferred embodiments (e.g. see FIGS. 1, 6, 7 and 8), some material is added between the bearing areas 14 and the opposite exit areas 30, e.g. optically clear adhesive or a transparent adhesive layer, this material forming a transitional layer 24 that must ensure indirect mutual connection of the bearing area 14 of the functional element 26b with the exit surface 30 on the one hand, and on the other hand, the material of the transitional layer 24 must ensure transmission of light rays 10 through the transitional layer 24 into the functional element 26b. Therefore, the technological layer 24 is preferably implemented as a layer with a refractive index approximating the refractive index of the light guide 15 and functional elements 26a. However, for the material of the transitional layer 24, material with a different refractive index from the refractive index of the light guide 15 or the material of the functional element 26b can also be used while in this case additional refraction of light on individual interfaces, which occurs due to different refractive indexes, can be technologically used.

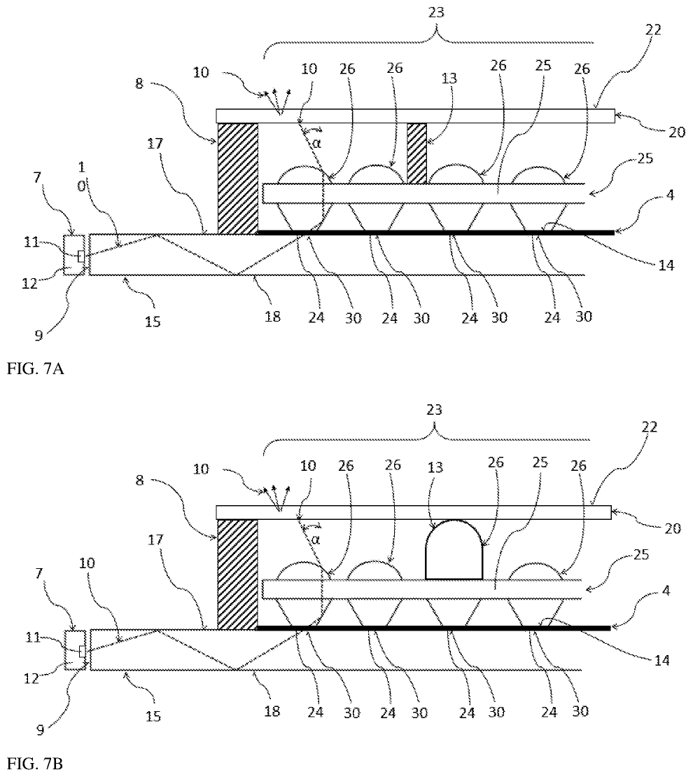

The transitional layer 24 can be of the same size and positionally aligned with the exit surface 30 and bearing area 14 so that the bearing area 14, transitional layer 24 and exit area 30 are arranged on each other in a precise alignment (see e.g. FIGS. 1 and 6); in other embodiments (see FIGS. 7 and 8), however, the technological layer 24 may be integral with a monolithic layer 4, preferably made of a single material.

The transitional layer 24 in the sense of this invention is a layer configured to eliminate the air gap between the exit surfaces 30 of the light guide 15 and the opposite bearing surfaces 14 of the functional elements 26, as the purpose is to prevent total reflection of light rays 10 on their incidence on the exit surfaces 30, and conversely to enable transition of these rays 10 through the transitional layers 24 into the functional elements 26b.

Note that the production process of the light unit 3 preferably comprises the step of using a light guide 15 whose entire front surface 17 is adapted for total reflection of light rays 10 passing along the light guide, i.e. the front surface is completely uniform in this sense. Thus, before connection to the optical assembly 23, the front surface 17 does not comprise any exit areas 30 because they will only be produced by attachment of the optical assembly 23 to the light guide 15. The exit areas 30 are created because in places where the bearing areas 14 are attached to the front surface of the light guide 15, either directly or via a transitional layer 24, the surface of the light guide will no longer form an interface between materials with a significantly different refractive index, and therefore light rays 10 will (with no or small refraction depending on whether the refractive indexes of the material of the light guide 15 and transitional layer 24 or light guide 15 and the functional element 26a are the same or slightly different) transit from the light guide 15 into the functional elements 26a.

In embodiments that comprise a carrier 25 (embodiments of FIGS. 1 to 14b), a separate light guide 15 and a separate optical assembly 23 are first produced during their production, and then the light guide 15 is connected to the optical assembly 23 in the places of the bearing areas 14 of the optical elements 26.

FIG. 2 shows a side view of a detail of an exemplary carrier 25 of the emitting element 26a and functional element 26b, which are carried by the carrier 25. The emitting element 26a, functional element 26b and carrier 25 are made of an optically transparent material. The carrier 25 has its front surface 25a, which the emitting elements 26a and the rear surface 25b with the functional elements 26b protrude over. The functional element 26b shown has at least one reflective area 27 to reflect light rays 10 towards the emitting element 26a whose exit area 29 light rays 10 are emitted from in predetermined directions. The refractive indexes of the material of the functional element 26b, carrier 25 and emitting element 26a can be approximately equal while in such a case there will be minimal refraction of light rays 10 on the interface formed by the rear side 25b and the front side 26a, or materials with different refractive indexes can be selected, which will cause refraction on the said interfaces, which must be taken into account in the design of the geometrical shape of the elements 26a and 26b to achieve the predetermined emission characteristics of light rays 10 from the exit area 29. As mentioned above, the optical element 26 comprising the functional element 26b and emitting element 26a can be an integral element made of the same material, i.e. an element where no interfaces are made, and in such a case, after the entry of light rays 10 into the optical element 26, no refraction of light rays occurs inside the optical element 26.

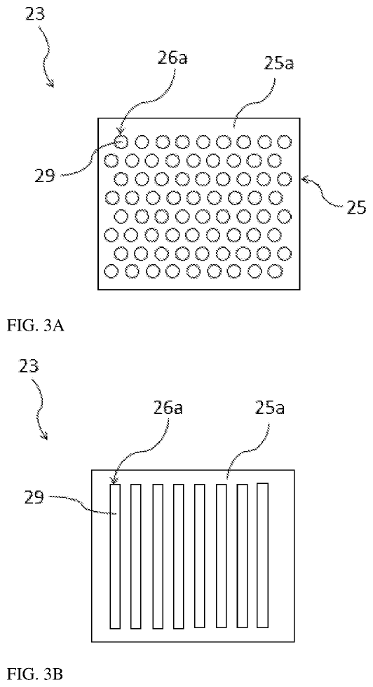

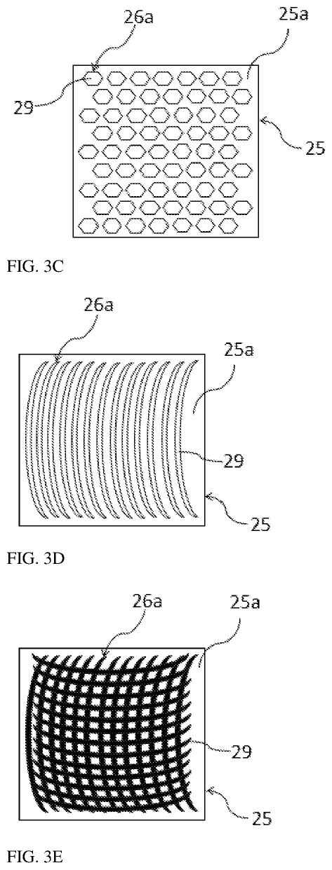

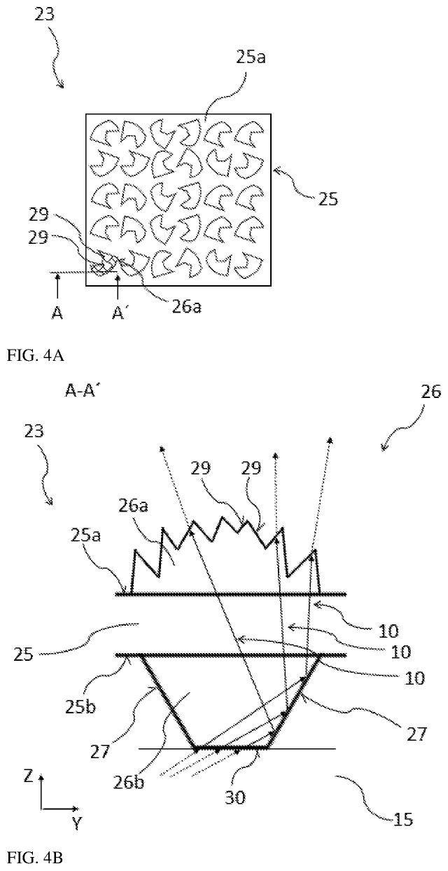

FIGS. 3A to 3E and FIG. 4A show a front view of the carrier 25, more particularly of its front surface 25a, and the emitting elements 26a protruding over the front surface 25a.

The emitting elements 26a shown in FIG. 3A e.g. have the form of ball-shaped lenses with a convex shape of the exit area 29 protruding over the front surface 25a of the carrier 25. The functional element 26b preferably has the shape of a truncated cone and the emitting element 26a preferably has the shape of a spherical cap—of the above-mentioned ball-shaped lens.

The emitting elements 26a shown in FIG. 3B are designed as cylindrical lenses, only influencing the route of light rays 10 on the plane perpendicular to the axis of this cylinder whereas on the plane delimited by the axis of the cylinder and the normal to the front surface 25a of the carrier 25, the route of the rays 10 is intentionally not influenced (refraction on the optical interface is applied only).

FIG. 3C shows emitting elements 26a whose shape is determined by spatially arranged surfaces.

FIG. 3D shows emitting elements 26a of a linear shape.

FIG. 3E shows emitting elements 26a that are mutually interconnected in such a way that they create the shape of a net or grid.

FIGS. 4A and 4B show an example of emitting elements 26a whose exit area 29 is composed of spatially arranged partial areas.

FIG. 5 shows another embodiment example of the lighting unit 3 according to the invention wherein two emitting elements 26a arranged next to each other, e.g. lenses, differ with their shape and size, and the adjacent functional elements 26b are also different from each other, e.g. with the shape of the reflective areas 27.

FIG. 6 shows another embodiment example of the lighting unit 3 according to the invention wherein behind a transparent light guide 15, a filter 21 is situated influencing the color appearance/background when the lighting unit 3 is viewed in the inactive state. In a preferred embodiment, the filter 21 has a dark color, e.g. black.

FIG. 7A shows another embodiment example of the lighting unit 3 according to the invention wherein on the front surface 17 of the light guide 15, a layer 4 is situated that comprises transitional layers 24. In front of the optical assembly 23, a filter 20 is preferably situated, having a superficial or internal volume structure influencing the flow direction of light rays 10. The filter 20 is separated from the optical assembly 23 with free space. The filter 20 may be e.g. a homogenizer adapted to homogenize—diffuse light rays 10. The material of the filter 20 can be e.g. a milk material or another material with a superficial or internal structure influencing the direction of light rays 10. Light rays 10 passing through the filter 20 and exiting from its exit surface 22 can be diffused in an isotropic or anisotropic way. The filter 20 may be adapted in such a way that it changes the wavelength of transmitted light or a semi-permeable mirror to achieve a mirror-like appearance. At least along a part of the perimeter of the lighting unit 3, a connecting element 8 is situated, e.g. a frame of any color, preferably of milk color or non-transparent. Inside the lighting unit, a spacing element 13 may be situated to ensure the required distance of individual components, especially the filter 20 and optical assembly 23.

As shown in FIG. 7B, the function of the spacing element 13 may also be fulfilled by the optical element 26 with a specific height as well as design, which then fulfills both the optical function and the spacing function.

FIG. 8 shows another embodiment example of the lighting unit 3 according to the invention wherein at least a part of the surface of the emitting elements 26a and/or the front surface 25a of the carrier 25 is fitted with coating 5, e.g. metal plating, color spray etc., which serves the function of a filter/homogenizer. In an alternative embodiment, the function of the filter/homogenizer is ensured by a microtexture/nanostructure obtained by mechanical treatment of the mold (graining), or degradation of the surface of the emitting element 26a and/or front surface 25a of the carrier 25.

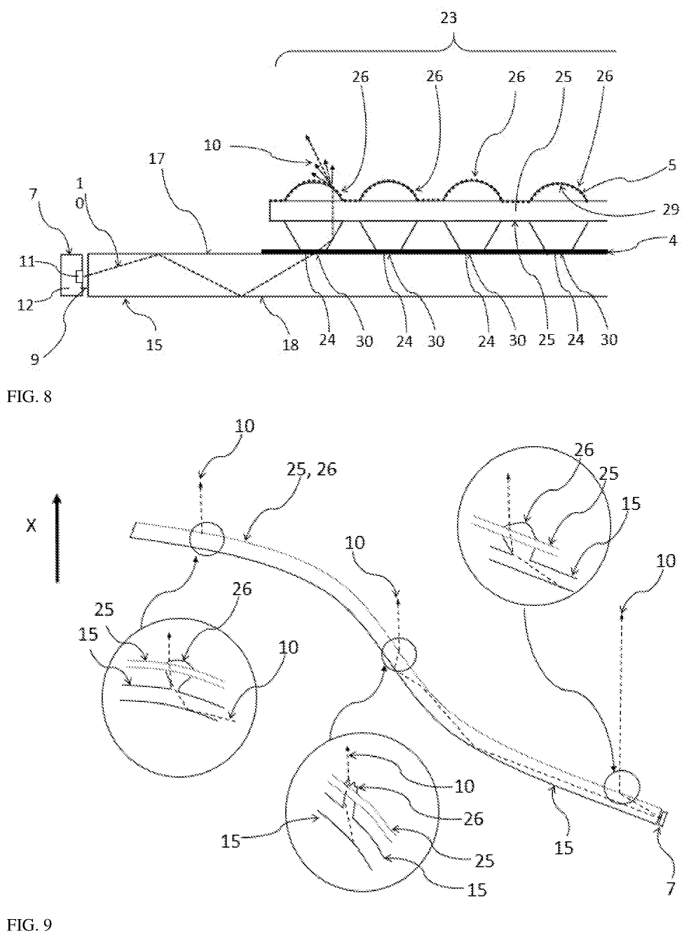

FIG. 9 shows another embodiment example of the lighting unit 3 according to the invention. In this case, the light guide 15 is undulated and to achieve that the beams of light rays 10 are sent in the required identical direction by individual optical elements 26, the optical elements 26 of the optical assembly 23 have different geometrical shapes.

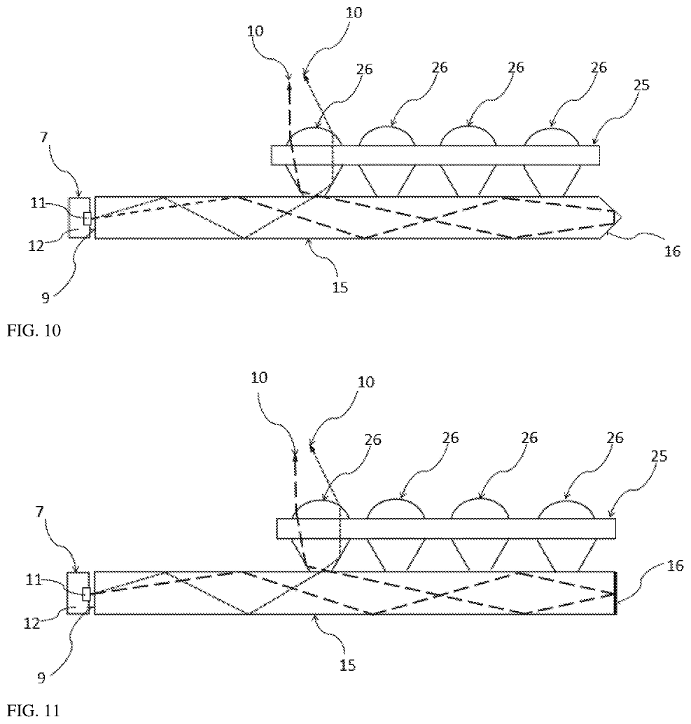

FIGS. 10 and 11 show another embodiment example of the lighting unit 3 according to the invention wherein the rear face 16 of the light guide 15 is adapted to reflect light rays 10.

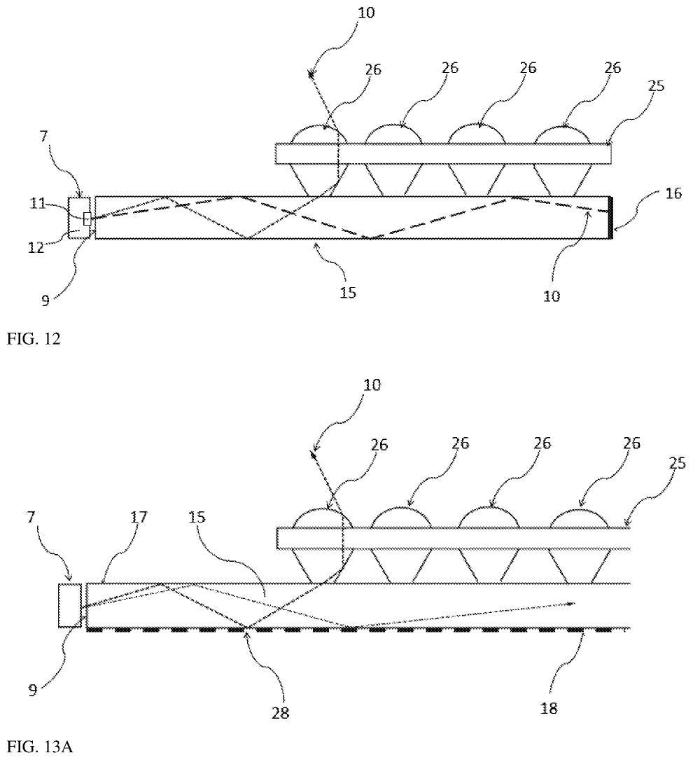

FIG. 12 shows another embodiment example of the lighting unit 3 according to the invention wherein the rear face 16 of the light guide 15 is adapted to absorb light rays 10.

FIG. 13A shows another embodiment example of the lighting unit 3 according to the invention wherein the rear surface 18 of the light guide 15 is fitted with unbinding elements 28 configured to direct light rays 10 in predetermined directions.

FIG. 13B shows another embodiment example of the lighting unit 3 according to the invention wherein the rear surface 18 of the light guide 15 is fitted with unbinding elements 28 configured to direct light rays 10 towards the front surface 17 of the light guide 15 in such a way that the light rays 10 can exit out of the light guide 15. Thus, the light rays 10 also exit, by the effect of the unbinding elements 28, from the front surface 17 through the intermediate areas 19, which are situated between the exit areas 30.

The thickness of the lighting unit 3 is preferably from 0.1 mm to 14 mm.

FIG. 15A shows the lighting unit 3 wherein the light guide 15 is configured as a carrier 25 carrying the optical elements 26 that comprise a bearing area 14 that the optical elements 26 indirectly bear on the exit areas 30 of the light guide 15 via a transitional layer 24 with.

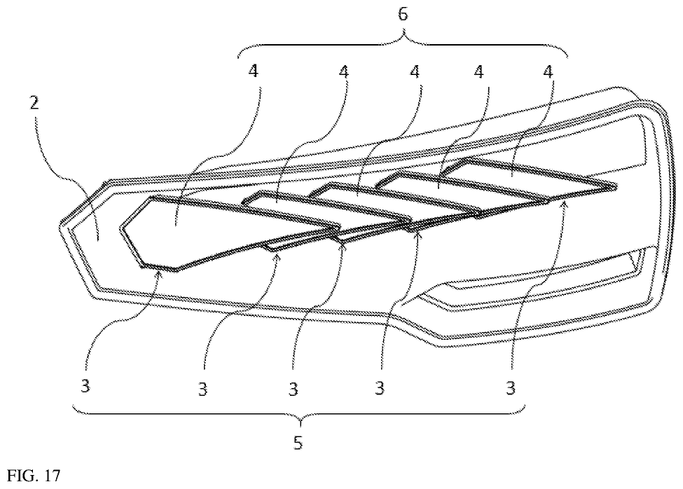

FIGS. 16 and 17 show examples of using the lighting unit 3 according to the invention in a light device of a car.

FIG. 16 shows a front view of a light device comprising a housing 1 defining a chamber 2 wherein one lighting unit 3 is seated, positioned in such a way that the emitting elements 26a emit light rays 10 out of the light device.

FIG. 17 shows a light device comprising multiple lighting units 3. The lighting units 3 can be arranged in the chamber 2 of a light device, especially a lamp, e.g. in such a way that some of the lighting units 3 will fulfill the requirements for the main beam and conversely, some of them will be designed to ensure visibility and/or to meet designer requirements. But at the same time, all the lighting units 3 of one lighting function must collectively meet the requirements of the legislative regulation for the particular function. Lighting units 3 can also be combined in such a way that one or more lighting units 3 are common for more lighting functions of the same color or more colors. E.g. a combination of the stop and tail function or the tail and turn indication function. Or a functional layer of one lighting unit can be designed in such a way to emit a part of the light to meet the requirement for visibility angles.

A relatively simplest configuration is such when the front surface 25a of the carrier 25 is situated approximately perpendicularly to the longitudinal axis of the vehicle and is approximately planar. However, this configuration is not always suitable for the style of the vehicle. Therefore, the optical assembly 23 or combination of optical assemblies 23 is adapted to redirect the main axis of the final light beam exiting from the optical assemblies 23. If there is an additional requirement that the optical assemblies 23 should be shaped and curved on the basis of designer requirements, optical analyses should be carried out and their results used to optimize the optical assemblies 23 or individual optical elements 26 to meet the legislative requirements for the particular function.

At present, motor vehicles are equipped with signal lamps designed to emit various light beams. Such signal lamps can be integrated in the body as separate lighting elements or they can be an integral part of headlights and tail lights in the form of a partial lighting unit.

Such functions are considered as signal functions that do not directly illuminate the space in front of the vehicle, but enhance road traffic safety by helping to improve visibility of the respective vehicle for the other road traffic participants. This mainly relates to the following functions:

DRL—Daytime running light, of white color

Turn indicator, of amber or red color

Front position light, of white color

Front parking light, of white color

Tail light, of red color

Stop light, of red color

High mount stop light (HMSL), of red color

Side marker, of white, amber or red color

Besides the required color of the light beam, each of the signal functions is characterized by visibility, which is based on the required directions and propagation angles of the light beam both on the horizontal and vertical plane as well as photometric requirements where in various angular areas in front of/behind the vehicle there are various areas with various required luminous intensity values.

### LIST OF REFERENCE MARKS

1—housing

2—chamber

3—lighting unit

4—layer

5—coating

7—light unit

8—connecting element

9—entry area

10—light ray

11—light source

12—carrier

13—spacing element

14—bearing area

15—light guide

16—rear face

17—front surface

18—rear surface

19—intermediate area

20, 21—filter

22—exit surface

23—optical system

24—transitional layer

25—carrier

25a—front surface

25b—rear surface

26—optical element

26a—emitting element

26b—functional element

27—reflective surface

28—unbinding element

29—exit area

30—exit area

1. A lighting unit for a light device of a motor vehicle, comprising a light guide to lead light rays from at least one light source, wherein the light guide comprises a front surface and an opposite rear surface, wherein the lighting unit further comprises a light assembly which is positioned against the front surface of the light guide and includes optical elements containing bearing areas with which the optical elements are in contact with and connected to the front surface of the light guide directly or indirectly in such a way that a transitional layer is situated between the front surface and the bearing areas, wherein the bearing areas are arranged next to each other and with spacings between each other, and the optical elements are configured to bind light rays falling onto the front surface in places of the said contact and connection of the front surface with the optical elements and to emit the light rays from exit surfaces of the optical elements in a predetermined direction or directions, so that the said places of contact and connection of the front surface with the optical elements define exit areas on the front surface for exit of the light rays from the light guide.

2. The lighting unit according to claim 1, wherein the rear surface of the light guide is smooth and without unbinding elements that would unbind the light rays from the light guide, so that the light guide is configured for the exit of the light rays out of the light guide through the exit areas only.

3. The lighting unit according to claim 1, wherein the rear surface of the light guide is provided with unbinding elements configured to direct light rays towards the exit areas and/or intermediate areas that are positioned between the exit areas and to ensure exit of the light rays through the exit areas and/or intermediate areas out of the light guide.

4. The lighting unit according to claim 1, wherein the light assembly comprises a carrier carrying the optical elements.

5. The lighting unit according to claim 1, wherein the optical elements comprise a functional element and an emitting element, which are directly or indirectly connected to each other, the functional element comprising a bearing area and at least one reflective area to reflect the light rays that have left the light guide through the exit area and entered the functional element through the bearing area, and to direct the light rays to the emitting element comprising an exit surface for the exit of the light rays out of the functional element.

6. The lighting unit according to claim 5, wherein the functional element protrudes from the rear surface of a carrier facing the front surface of the light guide, and the emitting element protrudes from the front surface of the carrier averted from the front surface of the light guide.

7. The lighting unit according to claim 4, wherein the optical elements are integral bodies embedded in the carrier.

8. The lighting unit according to claim 4, wherein the functional element and emitting element are separated from each other by the carrier.

9. The lighting unit according to claim 1, wherein one continuous layer is positioned between the bearing areas and the front surface and individual transitional layers are formed by sections of the continuous layer which are in contact with the bearing surfaces.

10. The lighting unit according to claim 1, wherein the light guide is longitudinally shaped or panel-shaped.

11. The lighting unit according to claim 4, wherein the carrier is panel-shaped or longitudinally shaped.

12. The lighting unit according to claim 5, wherein the emitting element has the form of a ball-shaped lens with a convex shape of the exit area and the functional element has the shape of a truncated cone whose smaller base is the bearing area.

13. The lighting unit according to claim 5, wherein the emitting element has an elongated shape.

14. The lighting unit according to claim 5, further comprising at least two emitting elements, wherein the emitting elements differ from each other with their shape and/or size.

15. The lighting unit according to claim 1, wherein the lighting unit comprises a filter situated behind the light guide to influence the color background when the lighting unit is viewed in its inactive state.

16. The lighting unit according to claim 1, wherein the light unit comprises a filter, the filter being situated at a distance in front of the optical assembly and comprising a superficial or internal volume structure to influence the flow direction of the light rays, or the filter being colored or metal-plated in a semi-permeable way.

17. The lighting unit according to claim 1, wherein the thickness of the lighting unit is from 0.1 mm to 14 mm.

18. The light device comprising a lighting unit according to claim 1, wherein the lighting unit is arranged to emit the light rays from the exit areas of the optical elements in a direction out of the light device.

19. The light device according to claim 18, wherein the light device comprises at least two lighting units, each of which being positioned to emit the light rays from the exit areas of the optical elements in a direction out of the light device, wherein the lighting units serve either one common light function of the light device, or at least two of the lighting units serve mutually different light functions of the light device.
